(19) United States
(12) Patent Application Publication
(10) Pub. No.: US 2022/0289018 A1
(43) Pub. Date: Sep. 15, 2022

(54) AIR CIRCULATION SYSTEM

(71) Applicant: HBPO GmbH, Lippstadt (DE)

(72) Inventor: Stefan Höwelkrüger, Delbruck (DE)

(73) Assignee: HBPO GmbH, Lippstadt (DE)

(21) Appl. No.: 17/689,404

(22) Filed: Mar. 8, 2022

(30) Foreign Application Priority Data
Mar. 12, 2021 (DE) 102021106053.2

(51) Int. Cl. B60K 11/08

(52) U.S. Cl. CPC B60K 11/085

(57) ABSTRACT

An air circulation system for a motor vehicle front end, having at least one air duct having an air inlet and an air control device. The air control device comprises at least one, in particular lamellar, air control flap which is mounted in pivot bearings and can be pivoted via a drive, in particular an actuator, in order to regulate the passage of air through the air inlet. The air duct comprises a foamed or injection-molded material at least in the region of the air control device, in particular in the region of the air inlet. At least one or a plurality of the pivot bearings is/are accommodated or formed in the foamed material.

### CROSS REFERENCE TO RELATED APPLICATIONS

This patent application claims priority on and the benefit of German Patent Application No. 10 2021 106 053.2 having a filing date of 12 Mar. 2021.

### BACKGROUND OF THE INVENTION

### Technical Field

The invention relates to an air circulation system which is used in particular for motor vehicle front ends.

### Prior Art

Corresponding air circulation systems have at least one air duct through which air sucked in from outside a vehicle can get into the interior of the vehicle. This air must be controlled under certain circumstances, which is why an air control device which in particular has lamellar air control flaps mounted in pivot bearings is generally used for this purpose. By changing the pivoting position of the air control flaps, more or less air can be sucked in at the air inlet. Such air control flaps are usually coupled to a controllable actuator so that the vehicle controller can operate this actuator and thus change the pivoting position of the air control flaps.

For this purpose, these air control flaps 4 are usually mounted in a frame 3 of the air control device 2, as shown in FIG. 2. This frame 3 contains corresponding pivot bearings in which corresponding pivot pins of the air control flaps 4 can engage. This frame is then inserted into the air duct, particularly in the region of the air inlet. However, such a frame construction requires the provision of a corresponding frame in which the air control flaps can be mounted. The frame, in turn, is then inserted into the air duct together with the mounted air control flaps and fixed there.

These frames must have a certain stability so that the air control device works properly even under high pressure from the outside. As electromobility technology progresses, vehicles are becoming heavier on average due to the batteries required, and it is therefore important to compensate for this increase in weight by saving weight in other areas. In particular, this requires new solutions in the design of motor vehicle front ends.

### BRIEF SUMMARY OF THE INVENTION

Therefore, the problem addressed by the present invention is that of providing an air circulation system and a motor vehicle front end having said system which meet the current requirements for weight reduction.

This problem is solved by an air circulation system, as well as a motor vehicle front end having an air circulation system, the air circulation system for a motor vehicle front end having at least one air duct having an air inlet and an air control device which has at least one, in particular lamellar, air control flap which is mounted in pivot bearings and can be pivoted via a drive, in particular an actuator, in order to control the passage of air through the air inlet, wherein the air duct comprises a foamed or injection-molded material at least in the region of the air control device, in particular in the region of the air inlet, wherein at least one or a plurality of the pivot bearings is/are accommodated or formed in the foamed material.

The air circulation system according to the invention for a motor vehicle front end has at least one air duct having an air inlet and an air control device, said air control device comprising at least one, in particular lamellar, air control flap mounted in pivot bearings. Said air control flap can be pivoted via a drive, in particular an actuator, in order to control the passage of air through the air inlet. The air duct comprises a foamed or injection-molded material at least in the region of the air control device, in particular in the region of the air inlet. According to the invention, at least one or a plurality of the pivot bearings is/are accommodated or formed in the foamed material.

The invention is based on the concept of using a lightweight material for the air duct, such as a sprayed or foamed material, for example polypropylene foam (EPP), thereby removing the need for the frame previously used to hold the air control flaps and connecting the pivot bearing for the air control flap directly to the material of the air duct. In this way, weight can be reduced compared to known solutions having a frame.

The manner in which the pivot bearings are fastened to the air duct can vary. According to a preferred embodiment, one or a plurality of the pivot bearings can be foamed into the foamed material or injection-molded into the injection-molded material. Corresponding pivot bearings can already be inserted into a corresponding mold during production of the air duct and are then already assembled so that only an actuator or the air control flaps have to be attached. This significantly reduces the assembly complexity and by injection-molding or foaming, the pivot bearing can be securely fastened to the air duct without the need for additional fastening elements.

Alternatively or additionally, one or a plurality of the pivot bearings can be frictionally, form-fittingly and/or integrally fastened in or on the foamed or injection-molded material, in particular in recesses formed in the foamed or injection-molded material. It is therefore possible here for individual fastening steps to be carried out only after the air duct has been produced.

The type of such connections is at the discretion of a person skilled in the art and must be adapted to the local conditions or the specific assembly situation. For example, one or a plurality of the pivot bearings can be connected to the foamed or injection-molded material via a screw connection. This is particularly advantageous if, for example, the air control device is to be removed for maintenance or repair purposes.

In principle, it is also possible for a plurality of the pivot bearings to be arranged on a connecting portion, in particular a strip, which is frictionally, form-fittingly and/or integrally connected to the foamed or injection-molded material. Such a connecting portion having a plurality of pivot bearings reduces the number of components required and in this respect makes for an easier assembly process. It is therefore conceivable that a plurality of pivot bearings are located on a single, integral component, for example a plastics material component.

Conversely, a plurality of the pivot bearings can be designed as sleeves or bushings which are in particular not connected to one another and in which a pivot bearing pin of the air control flap(s) is pivotally accommodated.

The pivot bearing(s) and/or the air control flap(s) is/are preferably made of a plastics material, in particular polypropylene (PP). Of course, other materials are also conceivable. The air circulation system described above is preferably part of a motor vehicle front end. Of course, it is also conceivable to accommodate a corresponding air circulation system on other components, in particular components of a vehicle.

### BRIEF DESCRIPTION OF THE DRAWINGS

The invention will be explained in more detail in the following with reference to FIGS. 1 to 15.

FIG. 1 shows an air circulation system according to a first embodiment according to the invention in perspective view.

FIG. 2 shows an air control device according to the prior art in perspective view.

FIG. 3 shows the air circulation system shown in FIG. 1 in exploded view.

FIG. 4 shows a second embodiment of the air circulation system according to the invention in perspective view.

FIG. 5 shows an air control device according to the invention in perspective view.

FIG. 6 and FIG. 7 show parts of the air control device shown in FIG. 5 in perspective view.

FIG. 8 shows a sectional illustration of a central region of the air circulation system according to the invention.

FIG. 9 and FIG. 10 show further parts of the air control device shown in FIG. 5 in perspective view.

FIG. 11 shows a sectional view of a section of the air control device shown in FIG. 5.

FIG. 12 shows a perspective partial view of an alternative embodiment of the air circulation system according to the invention having a sleeve-like pivot bearing.

FIG. 13 shows a sectional view through the embodiment of the air circulation system having a sleeve-like pivot bearing.

FIG. 14 shows a sectional view through a further embodiment of the air circulation system in a further fastening variant of the pivot bearing.

FIG. 15 shows a further sectional view through a further embodiment of the air circulation system having a screw fastening of the pivot bearing.

### DETAILED DESCRIPTION OF PREFERRED EMBODIMENTS

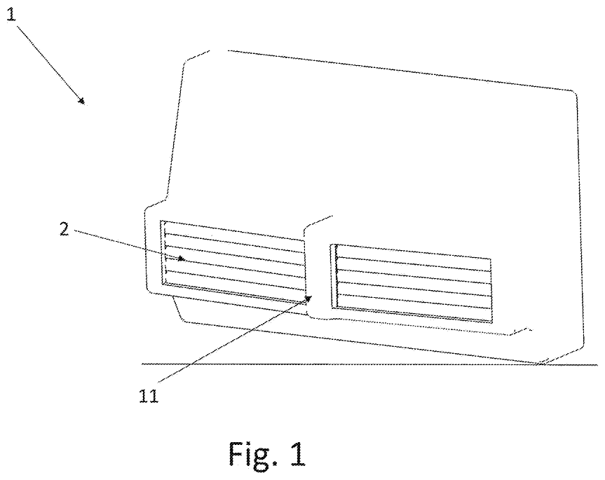

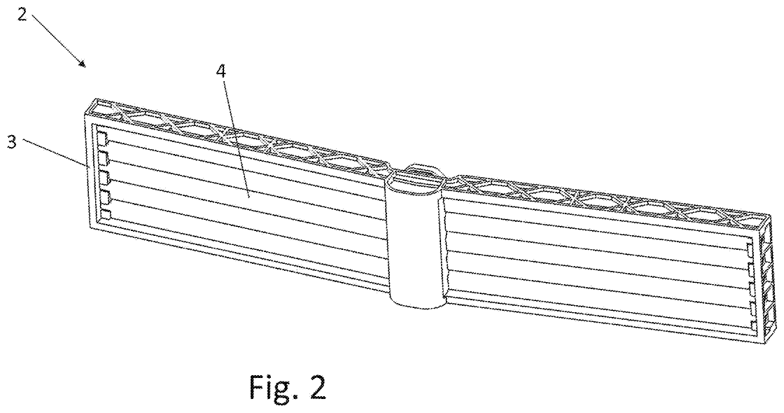

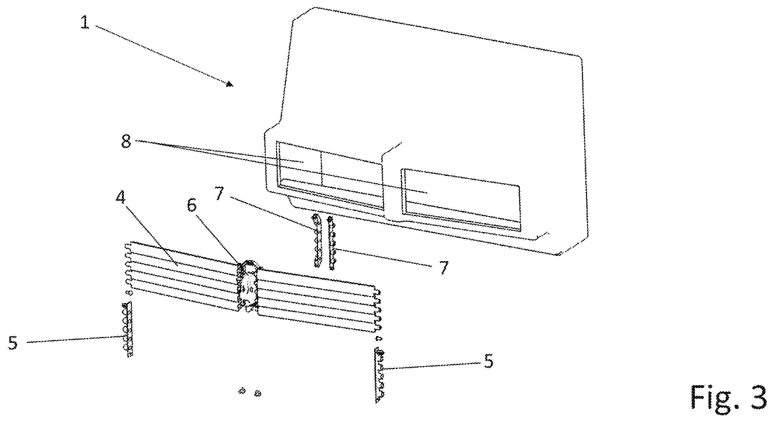

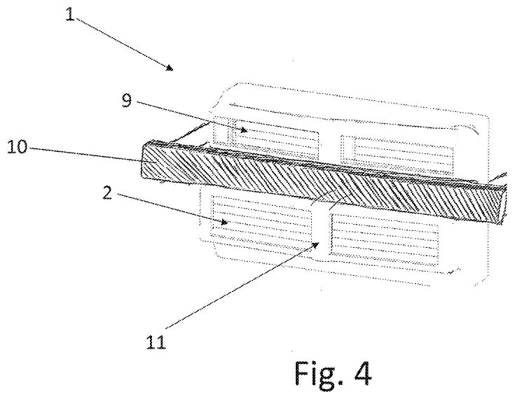

The air circulation system 1 shown in FIGS. 1 and 3 is generally a component which has an air duct through which the air entering the air duct from the outside is transported into the interior of a vehicle through an air inlet 8, or even a plurality of air inlets. To control the air flow entering through the air inlet 8, an air control device 2 is arranged in the region of the air inlet 8, which air control device has one or more air control flap(s) 4. This air control device 2 can control the air flow by pivoting the air control flap 4. To pivot the air control flap 4, a drive 6 which is preferably designed as an actuator is used, as in the example shown. In the example shown in FIGS. 1 and 3, two sets of air control flaps 4 are preferably arranged on either side of the actuator 6. The actuation of the drive 6 ensures that the air control flaps are pivoted. The actuator 6 is protected from the outside by a central projection 11 on the air circulation system 1. The air control flaps 4 are held pivotally in pivot bearings 5, 7 which are fastened to the air duct of the air circulation system 1, in particular in the region of the air inlet 8. FIG. 4 shows an alternative embodiment in which the air circulation system has two air control devices 2, 9, one of which controls the air flowing into the air inlets below a bending beam 10 and the other of which controls the air flowing into further air inlets above the bending beam 10. However, the number of air control devices 2, 9 is not important for the functioning of the air circulation system 1 according to the invention.

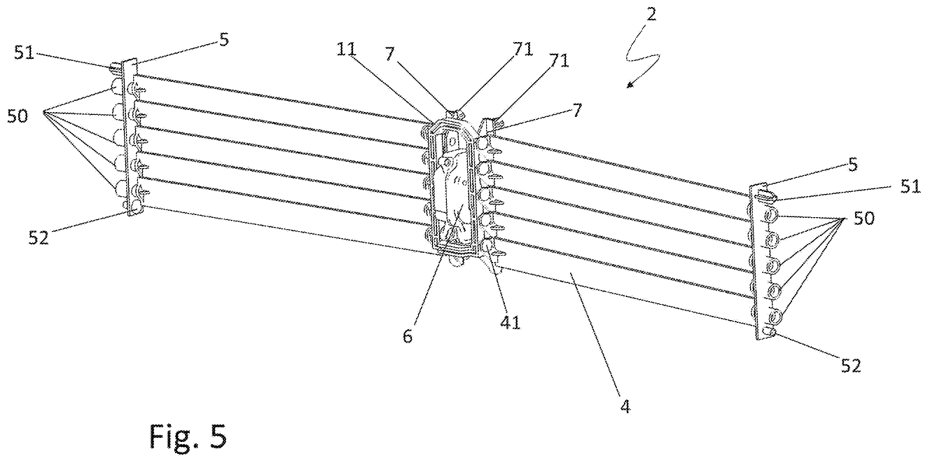

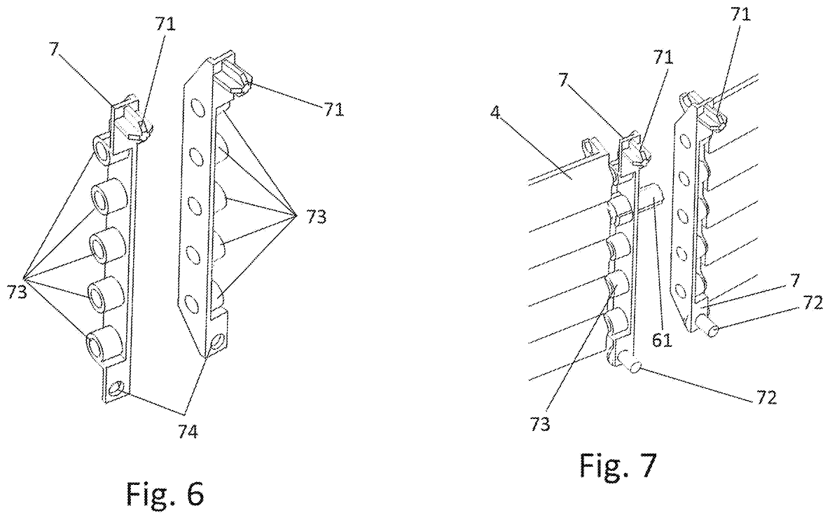

A first embodiment of the air control device 2 according to the invention will now be explained with reference to FIGS. 5 to 11.

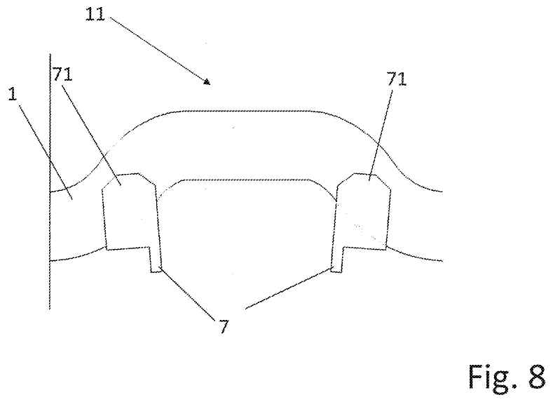

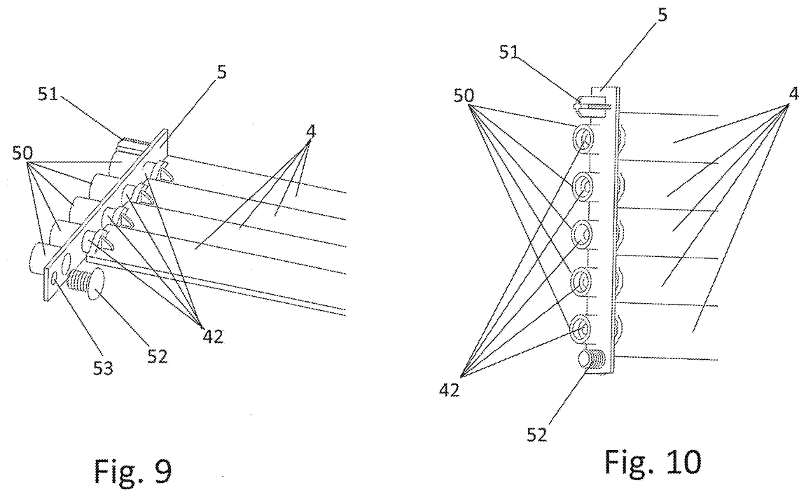

In the figures mentioned, only examples of air control devices 2 having a plurality of lamellar air control flaps 4 are shown. The invention works just as well having just one such air control flap 4. The air control flaps 4 have bearing pins or bearing portions 42 (cf. FIGS. 9 and 10) at their opposite ends in the direction of the pivot axis, by means of which pins or portions said flaps are mounted in or on pivot bearings 5, 7. The pivot bearings 5, 7 preferably have bearing bushes or bearing sleeves 50, 73 on or in which the bearing pins or bearing portions 42 are accommodated. A plurality of such bearing sleeves or bearing bushes 50, 73 are preferably arranged on projection-like or strip-shaped pivot bearing devices 5, 7 so that the number of components required can be reduced. These components 5, 7 or 50, 73 are preferably made of a plastics material, preferably PP. There are a number of options for the connection to the air circulation system 1 or the air duct. The pivot bearing devices 5, 7 shown can be injection-molded or foamed into the material of the air duct or air circulation system 1 during production, depending on whether the corresponding material is produced by an injection-molding process or a foaming process. It is just as possible to only provide recesses in this process, in which recesses corresponding portions of the pivot bearing devices 5, 7 can then be accommodated. It is thus possible for the pivot bearing devices 5, 7 to have further fastening portions 51, 53 or 71, 74 in addition to the bearing bushes or bearing sleeves 50, 73 mentioned. The fastening portions 51, 71 can be pressed into a corresponding recess in the air duct or in the air circulation system 1 and fixed therein frictionally or also integrally using an adhesive. This is shown by way of example in FIG. 8 for the fastening portions 71 which are attached in the air circulation system 1 in the region of the central projection 11. Alternatively or additionally, it is of course possible to form fastening portions 53 or 74 by means of holes through which corresponding fastening elements 52, 72 such as screws or the like are passed and fixed in the foamed or injection-molded material of the air circulation system 1 or the air duct. In the embodiment shown in FIGS. 5 to 11, it is preferable for the drive 6 to be housed between two pivot bearing devices 7 in the region of the projection 11. FIG. 7 shows the space between these two pivot bearing devices 7 without a drive; only a coupling axis 61 indicates that at this point one of the air control flaps 4 can be connected to the drive 6 via the coupling axis. The remaining air control flaps 4 can be connected to this driven air control flap 4 via a coupling. Of course, other coupling options are also conceivable.

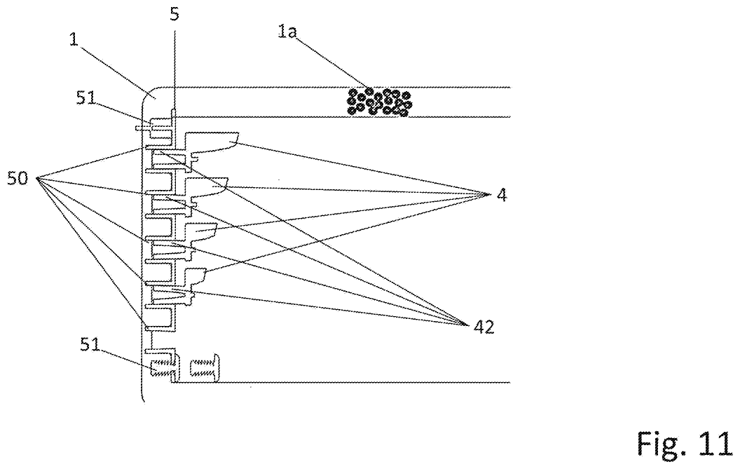

The sectional view shown in FIG. 11 clarifies once again how the outer pivot bearing device 5 can be connected to the relevant portion of the air circulation system 1, for example. 1a indicates that it can be a foamed material. It can be clearly seen here that the pivot bearing device 5 is form-fittingly connected to the material of the air circulation system 1. Also visible are the pivot bearing pins 42 of the air control flaps 4 that are accommodated in corresponding bearing bushes 50 on the pivot bearing device 5. The two optional fastening options via a frictional and/or integral connection (above the bearing bushes 50) or screw connection (below the bearing bushes 51) are also indicated.

The pivot bearing devices 5, 7 are preferably injection-molded or foamed into the material of the air circulation system 1.

Of course, it is also possible to connect corresponding bearing sleeves or bearing bushes individually to the material of the air circulation system 1 or air duct without corresponding bearing sleeves or bearing bushes 50, 73 being connected to one another, as is shown by way of the pivot bearing devices 5 or 7 in the embodiment of FIGS. 5 to 11.

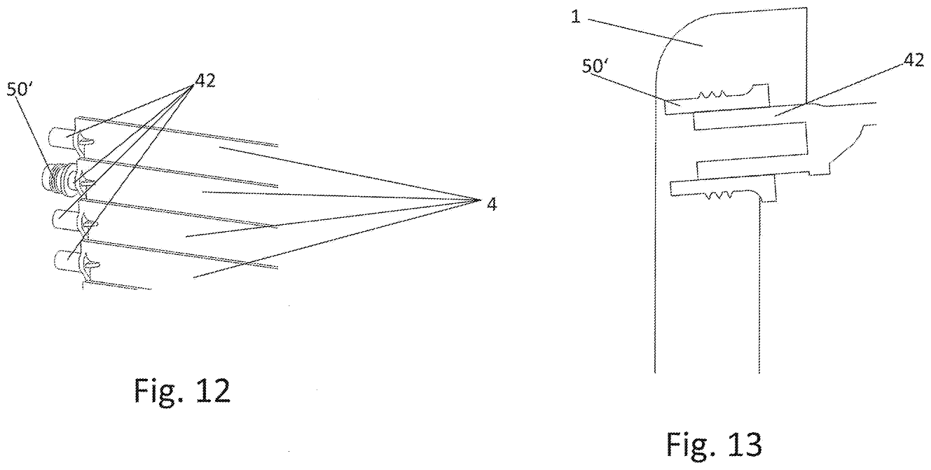

In this respect, FIGS. 12 to 15 contain some further embodiments.

A first embodiment of a bearing sleeve 50′ to be attached separately is shown in FIGS. 12 and 13. In this example, the bearing sleeve 50′ is injection-molded or foamed into the material of the air circulation system 1. For each individual air control flap 4, at least two bearing sleeves 50′ are injection-molded or foamed into the material, in which sleeves the corresponding bearing pins 42 of the air control flap 4 can then be accommodated. To produce such an arrangement, the bearing sleeves 50′ can be inserted into a mold as a simple insert before the injection-molding process or the foaming process begins.

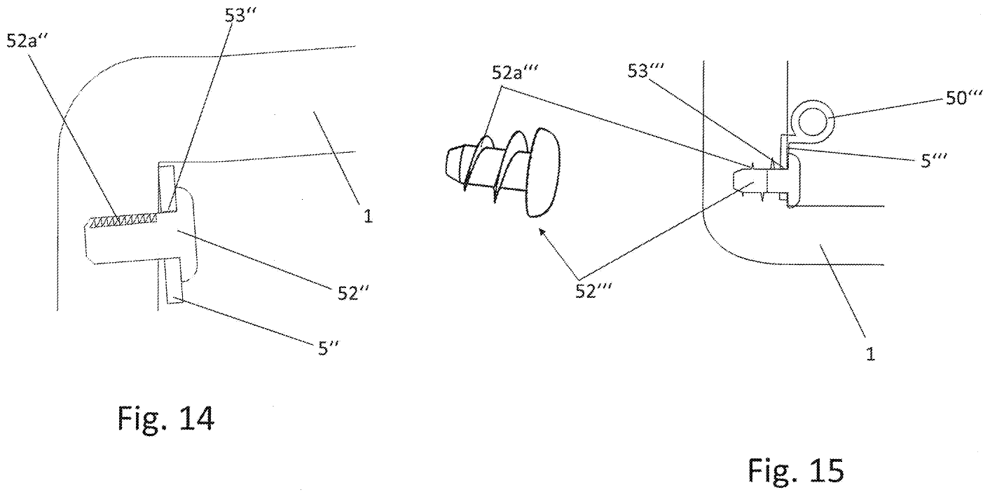

It is also possible to provide a pivot bearing device 5, 7 having corresponding recesses and a fastening element 52″ (FIG. 14) or 52′″ (FIG. 15) to be passed through such a recess 53″ or 53′″ and anchored in the injection-molded or foamed material of the air circulation system 1 or the air duct. Such a pivot bearing device 5, 7 can have only one bearing sleeve 50′″ or also a plurality of such bearing sleeves.

The type of anchoring in the foamed or injection-molded material can be produced in different ways, for example the corresponding fastening element 52″ can be a rivet, a self-tapping screw 52′″ having a corresponding wide spiral 52a which extends into the foamed or injection-molded material of the air circulation system 1 or the air duct, or a simple bolt which is fastened by means of adhesion in a recess provided in the material of the air circulation system 1 or the air duct. Finally, it is also possible to design such a fastening element 52″ having dowel-like or rib-like projections with or without undercuts that are pressed into a recess provided in the material of the air circulation system 1 or the air duct. The corresponding fastening element 52″ is held in the corresponding recess by the ribs, undercuts or the like. This can also be additionally supported using adhesive.

What is claimed is:

1. An air circulation system (1) for a motor vehicle front end, having at least one air duct having an air inlet (8) and an air control device (2) which has at least one, in particular lamellar, air control flap (4) which is mounted in pivot bearings (5; 50; 50′; 50′″; 7; 73) and can be pivoted via a drive (6), in particular an actuator, in order to control the passage of air through the air inlet (8), wherein the air duct comprises a foamed or injection-molded material at least in the region of the air control device (2), in particular in the region of the air inlet (8), wherein at least one or a plurality of the pivot bearings (5; 50; 50′; 50′″; 7; 73) is/are accommodated or formed in the foamed material.

2. The air circulation system (1) according to claim 1, wherein the foamed material is EPP.

3. The air circulation system (1) according to claim 1, wherein one or a plurality of the pivot bearings (5; 50; 50′; 50′″; 7; 73) is/are foamed into the foamed material or injection-molded into the injection-molded material.

4. The air circulation system (1) according to claim 1, wherein one or a plurality of the pivot bearings (5; 50; 50′; 50′″; 7; 73) is/are frictionally, form-fittingly and/or integrally fastened in or on the foamed or injection-molded material, in particular in recesses formed in the foamed or injection-molded material.

5. The air circulation system (1) according to claim 1, wherein one or a plurality of the pivot bearings (5; 50; 50′; 50′″; 7; 73) is/are connected to the foamed or injection-molded material via a screw connection.

6. The air circulation system (1) according to claim 1, wherein a plurality of the pivot bearings (5; 50; 50′; 50′″; 7; 73) are arranged on a connecting portion (5, 7), in particular a strip, which is frictionally, form-fittingly and/or integrally connected to the foamed or injection-molded material.

7. The air circulation system (1) according to claim 1, wherein a plurality of the pivot bearings (5; 50; 50′; 50′″; 7; 73) are sleeves or bushings (50′) which are in particular not connected to one another and in which a pivot bearing pin (42) of the air control flap(s) is pivotally accommodated.

8. The air circulation system (1) according to claim 1, wherein the pivot bearing(s) (5; 50; 50′; 50′″; 7; 73) and/or the air control flap(s) is/are made of a plastics material, in particular PP.

9. A motor vehicle front end, having an air circulation system having at least one air duct having an air inlet (8) and an air control device (2) which has at least one, in particular lamellar, air control flap (4) which is mounted in pivot bearings (5; 50; 50′; 50′″; 7; 73) and can be pivoted via a drive (6), in particular an actuator, in order to control the passage of air through the air inlet (8), wherein the air duct comprises a foamed or injection-molded material at least in the region of the air control device (2), in particular in the region of the air inlet (8), wherein at least one or a plurality of the pivot bearings (5; 50; 50′; 50′″; 7; 73) is/are accommodated or formed in the foamed material.

10. The motor vehicle front end according to claim 9, wherein the foamed material is EPP.

11. The motor vehicle front end according to claim 9, wherein one or a plurality of the pivot bearings (5; 50; 50′; 50′″; 7; 73) is/are foamed into the foamed material or injection-molded into the injection-molded material.

12. The motor vehicle front end according to claim 9, wherein one or a plurality of the pivot bearings (5; 50; 50′; 50′″; 7; 73) is/are frictionally, form-fittingly and/or integrally fastened in or on the foamed or injection-molded material, in particular in recesses formed in the foamed or injection-molded material.

13. The motor vehicle front end according to claim 9, wherein one or a plurality of the pivot bearings (5; 50; 50′; 50′″; 7; 73) is/are connected to the foamed or injection-molded material via a screw connection.

14. The motor vehicle front end according to claim 9, wherein a plurality of the pivot bearings (5; 50; 50′; 50′″; 7; 73) are arranged on a connecting portion (5, 7), in particular a strip, which is frictionally, form-fittingly and/or integrally connected to the foamed or injection-molded material.

15. The motor vehicle front end according to claim 9, wherein a plurality of the pivot bearings (5; 50; 50′; 50′″; 7; 73) are sleeves or bushings (50′) which are in particular not connected to one another and in which a pivot bearing pin (42) of the air control flap(s) is pivotally accommodated.

16. The motor vehicle front end according to claim 9, wherein the pivot bearing(s) (5; 50; 50′; 50′″; 7; 73) and/or the air control flap(s) is/are made of a plastics material, in particular PP.
